(19) United States
(12) Patent Application Publication
(10) Pub. No.: US 2020/0218502 A1
(43) Pub. Date: Jul. 9, 2020

(54) COGNITIVE TAG LIBRARY FOR CUSTOM NATURAL LANGUAGE RESPONSE RENDERING

(71) Applicant: INTERNATIONAL BUSINESS MACHINES CORPORATION, ARMONK, NY (US)

(72) Inventors: Eric Andersen, Natick, MA (US); Brian L. Brinker, Jasper, GA (US)

(21) Appl. No.: 16/238,878

(22) Filed: Jan. 3, 2019

(51) Int. Cl. G06F 3/16; G06F 17/27; G06F 3/0481; G10L 15/22

(52) U.S. Cl. CPC G06F 3/167; G10L 15/22; G06F 3/0481; G06F 17/2705

(57) ABSTRACT

Systems, computer-implemented methods and computer program products for providing custom renderings with natural language responses are provided. Aspects include storing a plurality of tags parsers. Aspects include transmitting a request comprising request data that represents a user utterance input into a user device. Aspects include determining a type of device associated with the user device and a type of communication channel used by the user device to transmit the request. Aspects include receiving a cognitive output comprising response text and structured data. Aspects include parsing one or more tags associated with the structured data of the cognitive output based on the application of one or more tag parsers of the plurality of tag parsers to the cognitive output. Aspects also include generating a customized response rendering for display by the user device.

### BACKGROUND

The present invention generally relates to natural language processing, and more specifically, to providing custom renderings with natural language responses.

Automated natural language systems can receive and process natural language inputs and return natural language results. For example, a user may input “What is my account balance?” and a natural language system may determine the meaning of the user utterance (i.e., a balance inquiry) and can return a result such as for example, outputting “$100.00.” Such natural language inputs can be input into various types of devices (e.g., mobile phone, desktop, ATM, etc.) and communicated over various different types of channels (e.g., software application, website, phone line, SMS (text message), ATM system, kiosk system, etc.), however conventionally, the natural language response is delivered in the form of text without regard to the type of device or communication channel being used.

### SUMMARY

Embodiments of the present invention are directed to a computer-implemented method for providing custom renderings with natural language responses are provided. A non-limiting example of the computer-implemented method includes storing a plurality of tags parsers. Each tag parser of the plurality of tag parsers can be configured to detect and parse an associated tag in data. Parsing a tag may include transforming the format of a detected tag for use in generating a customized rendering. The method also includes transmitting a request comprising request data that represents a user utterance input into a user device by the user device. The method also includes determining a type of device associated with the user device and a type of communication channel used by the user device to transmit the request based on the request data. The method also includes receiving a cognitive output comprising response text and structured. The method also includes parsing one or more tags associated with the structured data of the cognitive output based on the application of one or more tag parsers of the plurality of tag parsers to the cognitive output. The method also includes generating a customized response rendering for display by the user device based on the parsed one or more tags associated with the structured data of the cognitive output, the type of device associated with the user device, the type of communication channel used by the user device to transmit the request, and the response text.

Embodiments of the present invention are directed to a system for providing custom renderings with natural language responses are provided. The system includes a memory having computer readable computer instructions, and a processor for executing the computer readable instructions. The computer readable instructions include instructions for storing a plurality of tags parsers. Each tag parser of the plurality of tag parsers can be configured to detect and parse an associated tag in data. Parsing a tag may include transforming the format of a detected tag for use in generating a customized rendering. The computer readable instructions also include instructions for transmitting a request comprising request data that represents a user utterance input into a user device by the user device. The computer readable instructions also include instructions for determining a type of device associated with the user device and a type of communication channel used by the user device to transmit the request based on the request data. The computer readable instructions also include instructions for receiving a cognitive output comprising response text and structured data. The computer readable instructions also include instructions for parsing one or more tags associated with the structured data of the cognitive output based on the application of one or more tag parsers of the plurality of tag parsers to the cognitive output. The computer readable instructions also include instructions for generating a customized response rendering for display by the user device based on the parsed one or more tags associated with the structured data of the cognitive output, the type of device associated with the user device, the type of communication channel used by the user device to transmit the request, and the response text.

Embodiments of the invention are directed to a computer program product for providing custom renderings with natural language responses are provided, the computer program product comprising a computer readable storage medium having program instructions embodied therewith. The computer readable storage medium is not a transitory signal per se. The program instructions are executable by a processor to cause the processor to perform a method. A non-limiting example of the method includes storing a plurality of tags parsers. Each tag parser of the plurality of tag parsers can be configured to detect and parse an associated tag in data. Parsing a tag may include transforming the format of a detected tag for use in generating a customized rendering. The method also includes transmitting a request comprising request data that represents a user utterance input into a user device by the user device. The method also includes determining a type of device associated with the user device and a type of communication channel used by the user device to transmit the request based on the request data. The method also includes receiving a cognitive output comprising response text and structured data. The method also includes parsing one or more tags associated with the structured data of the cognitive output based on the application of one or more tag parsers of the plurality of tag parsers to the cognitive output. The method also includes generating a customized response rendering for display by the user device based on the parsed one or more tags associated with the structured data of the cognitive output, the type of device associated with the user device, the type of communication channel used by the user device to transmit the request, and the response text.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a system upon which providing custom renderings with natural language responses may be implemented according to one or more embodiments of the present invention;

FIG. 5 depicts a flow diagram of a method for providing custom renderings with natural language responses according to one or more embodiments of the invention; and

FIG. 6 depicts a flow diagram of an example cognitive tag library design logic according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

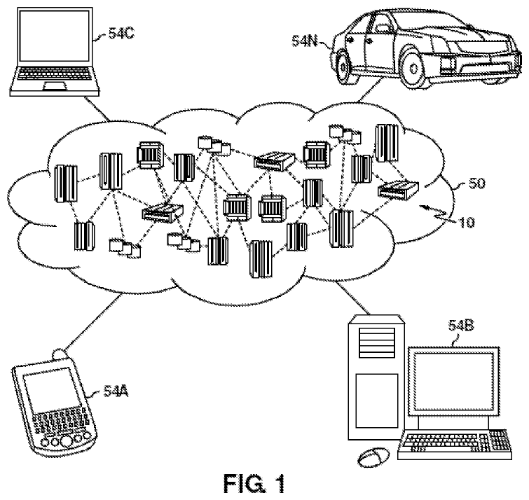

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

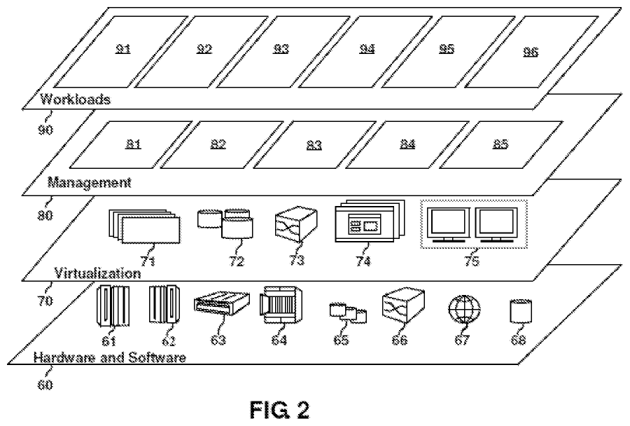

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing custom renderings with natural language responses 96.

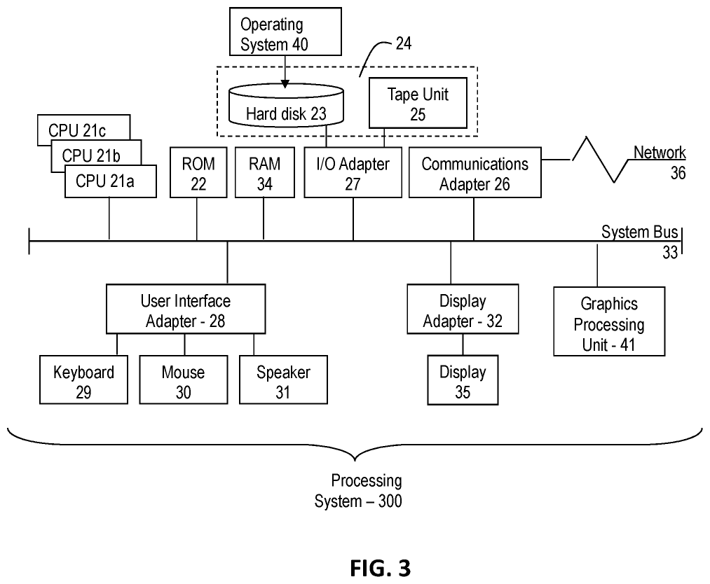

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

In exemplary embodiments, a system for providing custom renderings with natural language responses is provided. In exemplary embodiments, the system may receive a user input that is representative of a user utterance and provide a natural language response to the user utterance that can be presented in a customized rendering that can include interactive user interface widgets based on structured data. The disclosed systems provide a technical improvement over conventional systems by creating customized interactive renderings and/or displays based on the type of user device and communication channel being used by the user. The disclosed systems and methods can allow a user to have a much more useful interaction with the system by allowing data and interactive response options (e.g., buttons, input boxes, selectable lists, selectable menus, etc.) to be presented in a manner that is customized to the type of device and communication channel being used by the user. For example, a selectable dropdown menu may be easy to use in a website being accessed by a desktop computer but may not be easy to view or use on a software program running on a smart phone. Thus, selections of user interface widgets, data selected for display, text selected for display, colors, animations, sounds, or other user interface aspects or aspects of display of information can be customized based on one or more of the detected tags, the type of device and the communication channel used. The system can identify the type of device and communication channel used by the user and can detect and parse tags in cognitive outputs generated by the natural language processing/cognitive system to determine the nature of types of customized renderings to be generated for display in response to a user's utterance. The techniques disclosed herein can provide a consistent way to render and input data into a cognitive system across channels in a way that is unique to each channel. In contrast, conventional automated natural language processing response systems generally return only text without regard to the type of device or communication channel being used.

The disclosed systems and computer-implemented methods may include the use of a stored tag library that provides specific directions based on device and channel specifics and display and audio characteristics for generating specific formats and layouts for cognitive interaction using the various devices and channels. A tag library can be a stored lookup system that can translate directives from a cognitive system that are in the form of tags that represent format, layout and/or audio characteristics of material to provide to a user of the device. The system may use the tags to select the specific display and communication directions that render the directives appropriately for the specific device and channel used by the user. This information can be combined with the text and other related response data provided by the cognitive system and formulated into the appropriate widgets, text and/or audio. In other words, the system can generate specific display and communication characteristics in a graphical and/or voice-based interface that are tailored to the type of device and/or communication channel being used. For example, a user may ask the system “What are the last five transactions on my checking account?” and based on this user utterance, the system may generate a cognitive output representative of a request for the user to specify a date range and structured data representing possible dates that the system may then render, for example, as a message to the user that states “Please select the desired date range.” along with a rendering of an interactive date picker (i.e., a selectable calendar) that allows a user to select a date range of interest. The rendering generated to the user may be customized based on the type of user device and/or the type of communication channel being used to provide an improved ability by the usability to interact with the system. For example, if the communication channel is a voice call, the customized rendering may include, reformatting structured data, such as a table of transactions, for oral presentation by converting the table information into text to be automatically read aloud, such as “Your first transaction was for $5.00 on September 1^{st}. Your second transaction was for $10.00 on September 10^{th}.”

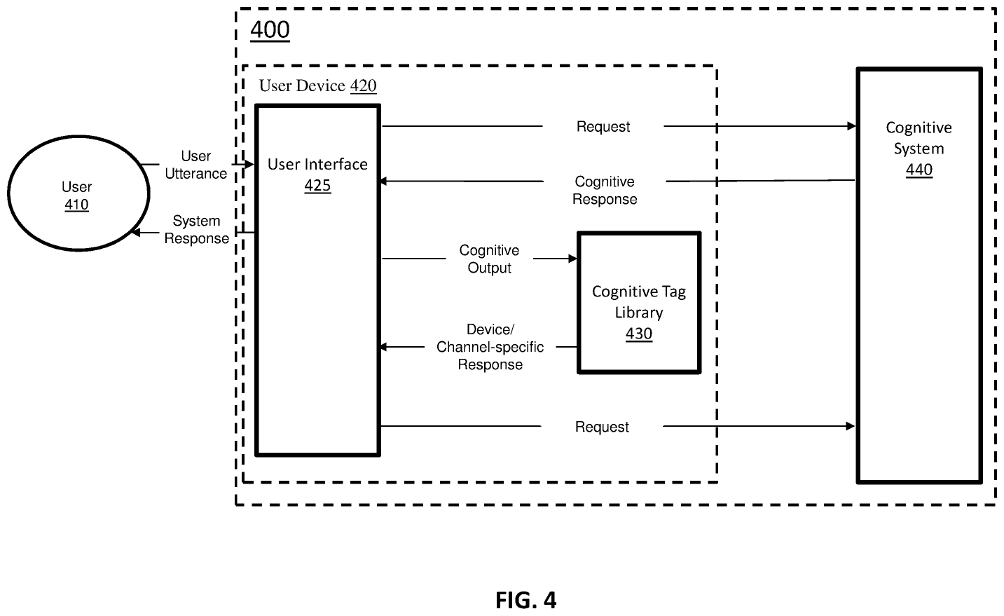

Turning now to FIG. 4, a system 400 for providing custom renderings with natural language responses will now be described in accordance with an embodiment. The system 400 includes a user device 420 and a cognitive system 440. The user device 420 includes a user interface 425 and a cognitive tag library 430. Although FIG. 4 depicts the cognitive tag library 430 as being stored on and/or executed by the user device 420, in alternative embodiments the cognitive tag library 430 may instead be stored on a remote server that can send instructions for the creation of custom renderings to the user device 420 for execution by the user device 420. For example, in some embodiments, the cognitive tag library 430 can be stored on and/or executed by a remote server that include cognitive system 440 or an intermediary server between user device 420 and cognitive system 440. User device 420 may be configured to communicate with cognitive system 440 via a communications network (not shown). The communications network may be one or more of, or a combination of, public (e.g., Internet), private (e.g., local area network, wide area network, virtual private network), and may include wireless and wireline transmission systems (e.g., satellite, cellular network, terrestrial networks, etc.). The user device 420 is generally configured to receive a user utterance, generate a request based on the user utterance, transmit the request to the cognitive system 440, and in response to receiving a cognitive response from the cognitive system 440, generate and display a custom rendering on the user interface 425. The custom rendering may be rendered by the user interface 425 based on a device and/or communication channel-specific response generated by the cognitive tag library 430, based on a cognitive output provided by the user interface 425. The custom rendering can include natural language response text and/or customized interactive elements based on the parsing of tags included in the cognitive output performed by the cognitive tag library 430. According to some embodiments, the custom rendering can be customized based on the type of device that the user device 420 is (e.g., smart phone, desktop computer, ATM, tablet, etc.) and the type of communication channel being used (e.g., software application, an interactive web site, a voice call, an ATM communication system, a kiosk communication system, or a video chat).

Thus, using the system disclosed herein, a user may, for example, utter a natural language request into their device (e.g., “What reservation times do you have open?”) and receive a response that includes a customized rendering of structured data (e.g., text saying “Please select from the following open times:” and an interactive date picker display (i.e., a selectable calendar) that allows a user to select from a plurality of open times and dates from a calendar) that is customized for display on the type of device and via the type communication channel being used. According to some embodiments, because the cognitive tag library 430 can process both structured and unstructured data, the system can generate customized renderings that embed structured data within unstructured data, such as for example, embedding a table in the middle of text.

In exemplary embodiments, a user device 420 can include, but is not limited to, a smartphone, a laptop, a desktop computer, a wearable device such as a smartwatch, an augmented reality headset, a tablet device, a smart speaker, a television, a kiosk, an automated teller machine (ATM) or any other suitable electronic device. In some embodiments, a user device 420 may be implemented as a computer system such as the one shown in FIG. 3. According to some embodiments, a user device 420 can include one or more a processors, one or more sensors, a display and a transceiver. The sensors can include one or more of an image capture device (e.g., digital camera) for obtaining images and/or videos, a microphone for obtaining audio recordings, and a location sensor for obtaining location data of the user device (e.g., GPS coordinates). User devices 420 include a user interface 425 that allows the user device 420 to interact with a user 410. A user interface 425 can includes one or more of an input device, a display, a touchscreen, a keyboard, a microphone, speakers or other audio outputs, and any other such features that can allow a user to input and receive information to and from the user device 420. The user device 420 can receive and/or detect user utterances via the user interface 425. For example, input devices, such as a keyboard or touchscreen, can receive user input text from a user 410. Text can also be input by a user 410 orally via a microphone using voice recognition. In some embodiments, the display is configured to display images, video, interactive user interfaces, website interfaces, and other such electronically displayed data and information. In some embodiments, the display can be a touchscreen that may be configured to detect tactile user inputs (e.g., typing, pressing, swiping, etc.) from a user 410. A transceiver can be configured to allow a user device 420 to communicate with other devices via a communications network (e.g., via Wi-Fi, cellular communications, etc.).

In some embodiments, the cognitive tag library 430 can be a software module that is stored on and executed by the user device 420. According to some embodiments, the cognitive tag library 430 may include a plurality of stored tags and a corresponding plurality of stored tag parsers that may be individually invoked upon determining that a corresponding tag is present in a cognitive output. As shown in FIG. 4, in some embodiments, the cognitive tag library 430 may receive a cognitive output based on a cognitive response received by the user device 420 from the cognitive system 440. For example, the user device 420 (e.g., the user interface 425) may receive the cognitive response from the cognitive system 440, remove a portion of text that is not part of the cognitive output, and forward the cognitive output to the cognitive tag library for processing. As described below, the cognitive response and cognitive output may include one or more cognitive tags (alternatively, “tags”) associated with data. The cognitive tag library 430 may be configured to analyze the cognitive output to identify whether the data includes one or more of the stored tags. Upon identifying the presence of a tag, the cognitive tag library 430 can select and apply the corresponding tag parser to the tag to parse and/or transform the data associated with the tag in accordance with the instructions associated with the tag parser. For example, a cognitive output may include a date picker tag that is associated with a range of dates, and the cognitive tag library may identify the presence of the date picker tag and apply a date picker tag parser to the data associated with the date picker tag to, for example, generate a date picker widget that displays the associated range of dates. Tag parsers may perform various functions such as removing the tag and/or data associated with the tag from the request/cognitive output, storing the data associated with the tag, transmitting the data associated with the tag to another device, or generating a user interface widget based on structured data associated with the tag. Although requests generated from user utterances will generally just be text, in some embodiments it is possible that requests may also include tags to be parsed by cognitive tag library 430 to modify the format the request into a cognitive input so that it may be more easily processed by the cognitive system 440. Thus, in some embodiments, a request may be first processed by the cognitive tag library 430 prior to being transmitted to the cognitive system 440.

In some embodiments, a cognitive system 440 can be embodied on a computing device that includes one or more processors and a memory for implementing the cognitive system 440. The cognitive system 440 can be configured to use natural language processing (NLP) techniques to process a request or cognitive input and generate a cognitive response that includes a cognitive output that may or may not include one or more tags associated with structured data. As will be appreciated by those of skill in the art, NLP techniques may be applied to allow the cognitive system 440 to determine the meaning of a user utterance obtained by the user device 420 and formulate a natural language response to the user utterance that can include requested data (e.g., account balances) and/or user interface widgets seeking further information from the user (e.g., a date picker asking a user to select a range of dates). In some embodiments, the cognitive system 440 may be an automated chat bot system that can automatically interact with a user 410 of a user device 420 to provide natural language responses to user utterances. According to some embodiments, the server storing cognitive system 440 may also be configured to store and execute the cognitive tag library 430. As described previously above, a cognitive tag library 430 may include a plurality of tag parsers that are each associated with a respective tag. A tag parser may be a set of instructions that when executed, can parse data to execute some functionality based on the presence of a corresponding tag in the cognitive output, such as for example, removing the tag from the data, parsing the tag and identifying it as data to be sent to another system or database, generating a set of instructions for providing a customized rendering that may include a widget, such as a date picker, a drop down menu, one or more selectable buttons, and the like, or any other such function as may be appropriate. According to some embodiments, the cognitive tag library 430 may receive a request from user device 420 that represents a user utterance (such as “What is my account balance?”) or other user input. The cognitive tag library 430 may parse a cognitive output or a request to detect any known tags present in the data and may parse or transform the tags using respective tag parsers to perform some function in relation to the data associated with the tag, such as for example, reformatting the tagged data for processing by other parts of the system. In some embodiments, a user input made in response to a natural language system response may include some structured data (e.g., a selection of dates) that may be associated with tags that can be parsed by the cognitive tag library 430. According to some embodiments, one or more tag parsers can be applied to a request received from a user device 420 to format the request for processing by a cognitive system 440 by parsing tags included in the request. For example, a request provided by user device 420 may include sensitive information that is associated with a sensitive information tag, and the cognitive tag library 430 may identify the tag and parse the data to remove the sensitive information before sending a cognitive input to the cognitive system 440 for further processing. In this way, the cognitive tag library 430 can store the sensitive information and use it to populate the response to the user device 420 while maintaining the confidence of the sensitive information from the cognitive system 440 to provide increased information security.

In some embodiments, one or more tag parsers of the cognitive tag library 430 may also be applied to a cognitive output from the cognitive system 440 to detect tags in the cognitive output for, for example, the purpose of generating custom renderings at the user device 420. For example, if a cognitive output includes multiple radio button tags that are associated with some structured data of the cognitive output (e.g., the cognitive output may represent an intent to present a user with a selection of three options such as “yes”, “no”, and “I don't know”, that may each be associated with a selectable radio button), a radio button tag parser may parse the data and detect the presence of the various radio button tags and perform one or more functions relating to the data associated with the radio button tags. Each tag parser may also include one more associated sets of instructions for generating a customized rendering based on the presence of a corresponding tag and based on the type of user device and/or communication channel being used. For example, the radio button tag parser may be associated with a first set of instructions for generating a first rendering based on the presence of one or more radio button tags in a cognitive output for a laptop that is communicating via a website, whereas the radio button tag parser may be associated with a second set of instructions for generating a second rendering based on the presence of one or more radio button tags in a cognitive output for a mobile phone that is communicating via a mobile application. According to some embodiments, cognitive tag library 430 may use the detected and parsed tags to select specific display and communication directions for rendering the directives of the cognitive system 440 by user device 420. If more than one tag is included in a cognitive output, the cognitive tag library 430 can parse or transform each tag into the corresponding device-specific user interface widget, such as for example, a date-picker, buttons, check boxes, select-list, drop down menus, or any other such interactive widgets.

As will be appreciated, different renderings of the same information and/or interactive content (e.g., buttons, drop down menus, input fields, etc.) may be advantageously presented by renderings having different formats, layouts, or organization of data for different viewing and interaction using types of communication devices and communication channels. For example, a website viewed on a laptop computer may be able to display nested drop-down menus in a manner that is readily viewable and useable by a user, whereas nested drop-down menus may not easily fit on the small and touch-sensitive screen of a smart phone and so a different type of layout may be required to display the same information in that case. Likewise, a website may be suitable to authenticate a user by allowing the user to input a user name and password, whereas a wearable augmented reality display may be better suited to perform a user authentication by performing a retinal scan. Furthermore, the implementation of the rendering may be different based on the user device and/or communication channel. For example, a web site rendered in HyperText Markup Language (HTML) may be performed differently than a user interface rendered on a kiosk using a kiosk software platform. It should be appreciated these are only examples, and information can be advantageously presented in many different ways based on the nature of the information, the type of device being used and/or the type of communication channel being used and the examples described herein are not intended to be limiting in any way.

According to some embodiments, cognitive system 440 may be configured to receive a request from user device 420, process the request to determine the meaning of a user utterance associated with the request and generate a cognitive output that is embodied in a cognitive response that is sent back to the user device 420 for processing by the cognitive tag library 430. The cognitive system 440 may include natural language processing (NLP) capabilities that, as will be appreciated by those of skill in the art, may allow the cognitive system 440 to determine the meaning of a request, lookup up necessary information to be included in a response (e.g., retrieving account balances or other such requested information), and formulate a response that may be presented in natural language to the user. The response may be embodied as a cognitive output that may include unstructured data and/or structured data. For example, unstructured data may include text that says “Your last five transactions are:” and structured data may include a table displaying the user's last five transactions. If the response includes structured data (e.g., a table of information), the cognitive system 440 may include one or more known tags associated with the structured data in the cognitive response that are associated with the structured data. For example, if the structured data includes a table of recent transactions, the cognitive response may include a table tag that encapsulates the tabular data to indicate the presence of the table data. As described herein, the cognitive tag library 430 can parse the cognitive output to detect known tags and generate a custom rendering, such as a customized table widget for display by the user device 420. According to some embodiments, if the cognitive output includes only unstructured data, the cognitive tag library 430 will not detect any tags and may therefore simply forward the cognitive output to the user interface 425 as the response to be rendered without any customized widgets. However, if the cognitive output includes tags associated with the structured data, the cognitive tag library 430 can modify the cognitive output (or alternatively, generate a completely new output) to include instructions for generating device and/or channel-specific renderings that are then transmitted to user interface 425 for rendering. Thus, for example, in an embodiment where the cognitive tag library 430 is stored and executed on the user device 420, the user device 420 may receive the cognitive output (e.g., as a portion of the cognitive response) from the cognitive system 440, which can be processed by the cognitive tag library 430 to identify any known tags in the cognitive output. One or more tag parsers of the cognitive tag library 430 may then parse the tags to generate a customized rendering to be displayed by the user interface 425, which may include natural language response text from the cognitive system 440 and structured data and/or user interface widgets associated with the tags. In embodiments where the cognitive tag library 430 is stored and executed remotely from the user device 420 (e.g., on a remote server), the cognitive tag library 430 may receive the cognitive output from the cognitive system 440, may identify any tags in the cognitive output, and may create instructions for generating a customized rendering, which may be transmit to and processed by the user device 420 for display of the customized rendering by user interface 425.

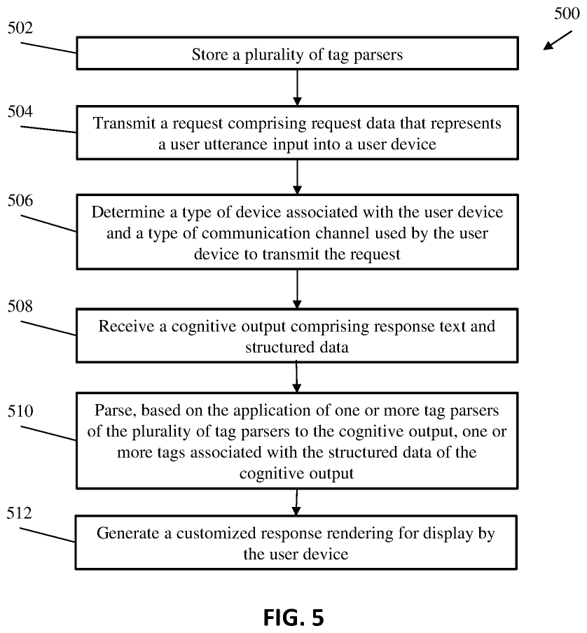

Turning now to FIG. 5, a flow diagram of a method 500 for providing custom renderings with natural language responses in accordance with an embodiment is shown. In one or more embodiments of the present invention, the method 500 may be embodied in software that is executed by computer elements located within a network that may reside in the cloud, such as the cloud computing environment 50 described herein above and illustrated in FIGS. 1 and 2. In other embodiments, the computer elements may reside on a computer system or processing system, such as the processing system 300 described herein above and illustrated in FIG. 3, or in some other type of computing or processing environment.

The method 500 begins at block 502 and includes storing (e.g., by user device 420) a plurality of tags parsers. According to some embodiments, each tag parser of the plurality of tag parsers can be configured to parse an associated known tag in data, following detection of the known tag within a dataset (e.g., within a cognitive output). Accordingly, a library of known tags may also be stored in association with the plurality of tag parsers. Parsing a tag may include one or more functions such as storing data associated with the tag, erasing data associated with the tag, transmitting data associated with the tag to another device, generating a customized rendering (e.g., a customized user interface widget) based on the tag and the associated data, or generating instructions for creating a customized rendering that may be transmitted to another device for execution. In some embodiments, each tag parser may be associated with a unique known tag. In some embodiments, tags can include, for example, one or more of a date picker tag, a table tag, a drop down list tag, a button tag, a link tag, a check box tag, an image tag, a login widget tag or a customized formatting tag. Thus, in some embodiments, a first tag parser may be associated with a date picker tag, and may be configured to analyze data (e.g., a cognitive output) to detect and/or parse date picker tags contained within the data. According to some embodiments, parsing a tag can include transforming the format of a detected tag for use in generating a customized rendering. This transformation of the tag is useful because different display platforms may have different required languages for rendering the tag and its contents, and so in some embodiments an untransformed tag may not be meaningful to the user device 420. According to some embodiments, each tag parser of the plurality of tag parsers may include associated instructions for generating a customized rendering based on a detected tag and optionally based on the type of user device being used and/or the type of communication channel being used. For example, the aforementioned first tag parser may be configured to parse data to detect or identify the presence of a date picker tag in the data, and in response to detecting the date picker tag, the tag parser may parse the date picker tag and execute the associated instructions for generating a customized rendering of a date picker based on the tag.

As shown at block 504, the method includes transmitting, by a user device (e.g., user device 420), a request including request data that represents a user utterance input into the user device. For example, a user may type or speak a user utterance such as “What is my account balance?” into a user device (e.g., user device 420) such as a smart phone and the user device may convert the user utterance into a request (e.g., a natural language request) and transmit the request to the cognitive system 440. According to some embodiments, the user device may transmit the request to a cognitive tag library 430 for processing prior to transmitting the request to the cognitive system 440. For example, in some embodiments, a request may include tags that can be parsed by the cognitive library 430 to place the request in a form that is more easily processed by the cognitive system 440. In some embodiments, the cognitive tag library 430 may be a software module that resides on the user device 420. Alternatively, in some embodiments, the cognitive tag library 430 may be a software module that resides on an external device such as a remote server.

As shown at block 506, the method includes determining a type of device associated with the user device (e.g., user device 420) and a type of communication channel used by the user device to transmit the request based on the request data. For example, the request may include metadata that provides an indication and/or identification of the type of user device and/or communication channel being used. In some embodiments, the user device 420, cognitive tag library 430 and/or cognitive system 440 may store a list of known user devices, device types and communication channels associated with user accounts and may determine the type of device and/or communication channel by performing a look-up in relation to a user account identification. For example, if a user is required to provide a login to a mobile application used for receiving user utterances, the system may authenticate the user during the login process and may determine the type of device and/or communication channel being used based on the authentication of the user. According to some embodiments, a type of device associated with a user device 420 may be one of a smart phone, a laptop, a desktop computer, a tablet device, a kiosk or an automated teller machine (ATM) or any other type of device in which it may be desirable to allow a user to interact with an automated natural language processing based response system. According to some embodiments, a type of communication channel used by the user device 420 to transmit the request can be one of software application, an interactive web site, a voice call, an ATM communication system, a kiosk communication system, or a video chat.

As shown at block 508, the method includes receiving a cognitive output comprising response text and structured data based on the request. For example, as described previously above, cognitive system 440 can generate a cognitive output including tags associated with structured data in response to processing a request from the user device 420, which may have been preprocessed by the cognitive tag library 430. As will be understood by those of skill in the art, the cognitive system 440 can generate a cognitive output by, for example, determining the meaning of a user utterance, retrieving data based on the determined meaning of the user utterance and generating natural language response text based on the determined meaning of the user utterance and optionally on the retrieved data. The cognitive system 440 may insert tags into the cognitive output in association with various data, such as structured data. For example, the cognitive output may include a date picker tag associated with a range of dates, or a table tag that is associated with table data. According to some embodiments, the cognitive output may be embedded in a cognitive response that is sent from the cognitive system 440 to the user device 420.

As shown at block 510, the method includes parsing (e.g., by the cognitive tag library 430) one or more tags associated with the structured data of the cognitive output based on the application of one or more tag parsers of the plurality of tag parsers to the cognitive output. For example, in some embodiments, cognitive tag library 430 may iteratively parse a cognitive output to determine whether any known tags are present and based on the type of tag identified, can select and apply a corresponding tag parser of a plurality of tag parsers to the cognitive output to parse the tag. In some embodiments, a tag parser may be associated with a particular tag that can be represented by a string, and the cognitive tag library 430 may detect the presence of a tag in a cognitive output by attempting to match the string that represents the tag to a string of data included in the cognitive output. For example, the tag parser may look for the tag namespace, which is common to all tags sent by the cognitive system. According to some embodiments, each identified tag in the cognitive output may have data associated with it. For example, a date picker tag may have a range of dates associated with it that was specified by the cognitive system 440 when generating the cognitive output. As described previously above, parsing the tag can include generating instructions for creating a customized rendering that can include for example, a customized widget that incorporates the data associated with a parsed tag.

As shown at block 512, the method includes generating a customized response rendering for display by the user device 420. According to some embodiments, the system (e.g., cognitive tag library 430) may generate a customized response rendering based on the parsed one or more tags associated with the structured data of the cognitive output, the type of device associated with the user device, the type of communication channel used by the user device to transmit the request and the response text. According to some embodiments, the customized response rendering can be customized to be displayed by the type of device associated with the user device and using the type of communication channel used by the user device to transmit the request. As described previously, in some embodiments, the one or more tags can be one or more of, for example but not limited to, a date picker tag, a table tag, a drop down list tag, a button tag, a link tag, a check box tag, an image tag, a login widget tag or a customized formatting tag. According to some embodiments, generating a customized response rendering can include generating one or more of a date picker, a table, a drop down list, a button, a link, a check box, an image, a login widget or a customized formatting. For example, if the cognitive tag library detects a table tag and a button tag in a cognitive output from the cognitive system 440, the response to the user device 420 may include instructions for rendering a table and one or more selectable buttons in a format that is suitable for display on the type of user device 420 and communication channel being used.

According to some embodiments, the method 500 can further include transmitting the customized response rendering to the user interface 425 of the user device 420 for display or presentation by the user device 420. Based on the customized response rendering, the user device 420 can generate the customized rendering(s) dictated by the cognitive tag library 430 and present the rendering(s) to the user by for example, generating a display and/or creating an audio output. According to some embodiments, the rendering(s) may include one or more interactive elements or user interface widgets, such as buttons, drop-down menus, selectable links, and the like. In response to a user selecting an interactive element, the user device 420 may create one or more new requests that are transmitted to the cognitive system 440 and the process of method 500 may be repeated.

According to some embodiments, the method 500 can further include displaying (e.g., by user interface 425) a customized rendering that includes a user interface widget, receiving a user input associated with the user interface widget, and generating a new request based on the user input associated with the user interface widget. The user device 420 can then transmit the new request to the cognitive system 440 in a manner similar to the original request. In this way, the system 400 can facilitate efficient user input of data in response to natural language messages that are automatically generated by the cognitive system 440 to facilitate an ongoing conversation between a user 410 and, for example, a chat bot. Using interactive widgets that are presented in a customized manner based on the type of device and the communication channel being used, the system can allow the user to respond to prompts and queries from the cognitive system 440 by using efficiently presented interactive widgets and avoiding cumbersome text entry.

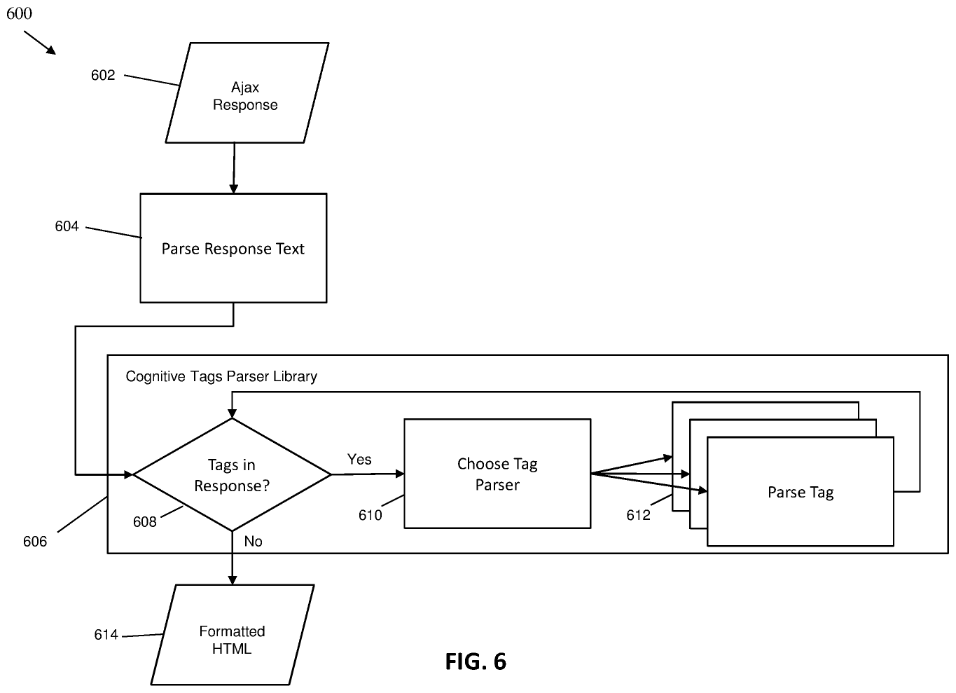

FIG. 6 depicts a flow diagram of an example cognitive tag library design logic according to one or more embodiments of the invention. The example in FIG. 6 provides an example that can be used for generating customized web site renderings and behaviors, although the logic presented in FIG. 6 may be adapted for use in generating renderings and behaviors for other types of communication channels as well. In one or more embodiments of the present invention, the method 600 may be embodied in software that is executed by computer elements located within a network that may reside in the cloud, such as the cloud computing environment 50 described herein above and illustrated in FIGS. 1 and 2. In other embodiments, the computer elements may reside on a computer system or processing system, such as the processing system 300 described herein above and illustrated in FIG. 3, or in some other type of computing or processing environment.

According to some embodiments, the method 600 may be implemented by a cognitive tag library 430 having plurality of tag parsers that can be stored on a user device 420. The method 600 begins at block 602 and includes receiving an Ajax (asynchronous JavaScript and XML) response (e.g., cognitive system 440). As will be appreciated by those of skill in the art, Ajax is a set of web development techniques that allow for the creation of asynchronous web applications. According to some embodiments, the Ajax response originates from the cognitive system 440 that a user is interacting with to provide user utterances or other user inputs. Block 604 can contain logic to parse the general response from the cognitive system 440; the output of this processing may then be passed to block 606 to look for tags from the cognitive system to be parsed. As shown in block 606, the method 600 includes parsing the response text of the ajax response in order to invoke the appropriate tag parser. Possible tags sent in the response might include for example but not limited to, date (which causes a date picker), list (which would cause a dropdown list or set of buttons), or range (which would cause a range input) to be rendered in the user device 420. Any kind of rich UI widget can be rendered, given a corresponding tag and tag parser. According to some embodiments, the tag includes all information needed to describe the contents of the rendered widget. As shown in block 606, the method 600 includes receiving and parsing tags from a tags library, such as for example, tag library 430 shown in FIG. 4. At block 608, the method 600 includes determining whether the response includes one or more tags, based on the results of a search for a pattern common to all tags. If the response does include tags, at block 610 the system chooses the appropriate tag parser and parses the tag at block 612. For example, if the response includes a button tag, and a button tag parser is selected at block 610, at block 612 the button tag parser will parse the button tag to generate an output that can be used in generating a custom rendering that includes one or more buttons and the behaviors required to collect the input(s) from those buttons and transmit the input(s) to the cognitive system. After a tag is parsed at block 612, the method 600 returns to block 608 to iteratively determine if there are any remaining unparsed tags in the response. Tag parsers are invoked based on the semantic type of tag encountered in the response. If for example, at block 610 the system detects within the response a table tag, the table tag parser is then invoked. The system will then cycle back to block 608 to look for more tags within the response. This cycle happens until all tags within the response are found and the appropriate tag parser is assigned for each. In response to determining that there are no more tags in the response at block 608, the method 600 advances to block 614 where the system (e.g., user interface 425 of user device 420) displays to the user the generated HTML, CSS, and/or JavaScript rendering based on the parsed tags that can be displayed as a webpage. In this way, the system can parse the tags in the response and based on each parsed tag can provide instructions for generating a customized web site rendering that includes a custom display of structured data associated with each of the parsed tags and the behavior required to handle the user interactions with the widget and return the result of those interactions to the cognitive system.

Additional processes may also be included. It should be understood that the processes depicted in FIGS. 5 and 6 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
storing, a plurality of tag parsers, each tag parser being configured to detect and parse an associated tag in data, wherein parsing a tag comprises transforming a format of a detected tag for use in generating a customized rendering;
transmitting, by a user device, a request comprising request data that represents a user utterance input into the user device;
determining, based on the request data, a type of device associated with the user device and a type of communication channel used by the user device to transmit the request;
receiving a cognitive output comprising response text and structured data;
parsing, based on an application of one or more tag parsers of the plurality of tag parsers to the cognitive output, one or more tags associated with the structured data of the cognitive output; and
generating, based on the parsed one or more tags associated with the structured data of the cognitive output, the type of device associated with the user device, the type of communication channel used by the user device to transmit the request, and the response text, a customized response rendering for display by the user device, wherein the customized response rendering comprises a graphical user interface having a customized format, layout and organization of data.

2. The computer-implemented method of claim 1, further comprising displaying the customized response rendering.

3. The computer-implemented method of claim 1, wherein the customized response rendering is customized to be displayed by the type of device associated with the user device and using the type of communication channel used by the user device to transmit the request.

4. The computer-implemented method of claim 1, wherein the type of user device is one of a smart phone, a laptop, a desktop computer, a tablet device, a kiosk or an automated teller machine.

5. The computer-implemented method of claim 1, wherein the type of communication channel used by the user device to transmit the request is one of a software application, an interactive website, a voice call, an ATM communication system, a kiosk communication system or a video chat.

6. The computer-implemented method of claim 3, wherein the one or more tags comprise one or more of a date picker tag, a table tag, a drop down list tag, a button tag, a link tag, a check box tag, an image tag, a login widget tag or a customized formatting tag.

7. The computer-implemented method of claim 6, wherein generating a customized response rendering comprises generating one or more of a date picker, a table, a drop down list, a button, a link, a check box, an image, a login widget or a customized formatting.

8. The computer-implemented method of claim 1, further comprising:
displaying the customized rendering, wherein the customized rendering includes a user interface widget;
receiving a user input associated with the user interface widget; and
generating, based on the user input associated with the user interface widget, a new request.

9. A system comprising:
a processor communicatively coupled to a memory, the processor configured to:
store, a plurality of tag parsers, each tag parser being configured to detect and parse an associated tag in data, wherein parsing a tag comprises transforming a format of a detected tag for use in generating a customized rendering;
transmit, by a user device, a request comprising request data that represents a user utterance input into the user device;
determine, based on the request data, a type of device associated with the user device and a type of communication channel used by the user device to transmit the request;
receive, a cognitive output comprising response text and structured data;
parse, based on an application of one or more tag parsers to the cognitive output, one or more tags associated with the structured data of the cognitive output; and
generate, based on the parsed one or more tags associated with the structured data of the cognitive output, the type of device associated with the user device, the type of communication channel used by the user device to transmit the request, and the response text, a customized response rendering for display by the user device, wherein the customized response rendering comprises a graphical user interface having a customized format, layout and organization of data.

10. The system of claim 9, wherein the processor is further configured to display the customized response rendering.

11. The system of claim 9, wherein the customized response rendering is customized to be displayed by the type of device associated with the user device and using the type of communication channel used by the user device to transmit the request

12. The system of claim 9, wherein the type of user device is one of a smart phone, a laptop, a desktop computer, a tablet device, a kiosk or an automated teller machine.

13. The system of claim 9, wherein the type of communication channel used by the user device to transmit the request is one of a software application, an interactive website, a voice call, or a video chat.

14. The system of claim 11, wherein the one or more tags comprises one or more of a date picker tag, a table tag, a drop down list tag, a button tag, a link tag, a check box tag, an image tag, a login widget tag or a customized formatting tag.

15. The system of claim 14, wherein generating a customized response rendering comprises generating one or more of a date picker, a table, a drop down list, a button, a link, a check box, an image, a login widget or a customized formatting.

16. The system of claim 9, the processor further configured to:
displaying the customized rendering, wherein the customized rendering includes a user interface widget;
receiving a user input associated with the user interface widget; and
generating, based on the user input associated with the user interface widget, a new request.

17. A computer program product comprising a computer readable storage medium having program instructions embodied therewith the program instructions executable by a computer processor to cause the computer processor to perform a method comprising:
storing, a plurality of tag parsers, each tag parser being configured to detect and parse an associated tag in data, wherein parsing a tag comprises transforming a format of a detected tag for use in generating a customized rendering;
transmitting, by a user device, a request comprising request data that represents a user utterance input into the user device;
determining, based on the request data, a type of device associated with the user device and a type of communication channel used by the user device to transmit the request;
receiving a cognitive output comprising response text and structured data;
parsing, based on an application of one or more tag parsers of the plurality of tag parsers to the cognitive output, one or more tags associated with the structured data of the cognitive output; and
generating, based on the parsed one or more tags associated with the structured data of the cognitive output, the type of device associated with the user device, the type of communication channel used by the user device to transmit the request, and the response text, a customized response rendering for display by the user device, wherein the customized response rendering comprises a graphical user interface having a customized format, layout and organization of data.

18. The computer program product of claim 17, wherein the method further comprises displaying the customized response rendering.

19. The computer program product of claim 17, wherein the customized response rendering is customized to be displayed by the type of device associated with the user device and using the type of communication channel used by the user device to transmit the request.

20. The computer program product of claim 17, further comprising:
displaying the customized rendering, wherein the customized rendering includes a user interface widget;
receiving a user input associated with the user interface widget; and
generating, based on the user input associated with the user interface widget, a new request.
